(19) United States
(12) Patent Application Publication
(10) Pub. No.: US 2018/0168180 A1
(43) Pub. Date: Jun. 21, 2018

(54) PACKAGED FOOD PRODUCT

(71) Applicant: MAGIC PRODUCTION GROUP (M.P.G.) S.A., FINDEL (LU)

(72) Inventors: Paolo VACCARELLA, BALDISSERO TORINESE (IT); Fabio QUARELLO, LUXEMBOURG (LU)

(73) Assignee: MAGIC PRODUCTION GROUP (M.P.G.) S.A., FINDEL (LU)

(21) Appl. No.: 15/738,760

(22) PCT Filed: Jun. 30, 2016
(86) PCT No.: PCT/IB2016/053928

§ 371 Date: Dec. 21, 2017

(30) Foreign Application Priority Data
Jun. 30, 2015 (IT) 102015000029005

(51) Int. Cl. A23G 1/54

(52) U.S. Cl. CPC A23G 1/545

(57) ABSTRACT

Package for a food product, comprising a first (2) and a second (4) half-shell of edible material, each having a respective annular edge (6, 8), said first and second half-shell of edible material being arranged with their respective annular edges in a mutually facing relationship, an openable container (12) of non-edible material interposed between said half-shells, having a wall that defines an internal volume for housing a product, article or accessory, wherein said first and second half-shell of edible material (2, 4) are accommodated in a respective wrapping (34, 36) of sheet material defining a cavity substantially complementary to the outer surface of the respective half-shell of edible material, said wrappings (34, 36) being connected to each other along their respective edges (40a, 40b) so as to maintain the half-shells of edible material (2, 4) in contact with the container wall, characterized in that the wall of at least one of said first and second half-shell of edible material (2, 4) has an opening with a closed contour (18, 20) defining a gap that makes a portion of the wall of the container (12) visible from the outside; preferably, the walls of the container have engagement means that engage the aforesaid opening or openings.

The present invention relates to a package for a food product, particularly for a confectionery product of the type comprising a first and a second hollow body or half-shell of edible material, the respective annular mouth edges of which are placed in mutually facing positions, so as to define a cavity in which is housed an openable container of non-edible material which, in turn, contains a product or an accessory article which is a surprise for the consumer.

In currently marketed products, the two chocolate half-shells are usually welded to each other along the respective facing mouth edges, and the food product is packaged in a wrapping of foil material adhering to the outer surface of the product.

EP 2 252 528 B1 describes a solution in which, to facilitate the opening of the package to access the surprise container, the ovoidal chocolate body is packaged in two flanged half-shells of foil material which are coupled to each other by the bending and crimping of the flange edges and in which the plane of separation of the chocolate half-shells coincides with the plane of the flanges.

The present invention tackles the problem of providing a packaged product in which, when the package is opened, that is to say after the removal of the packaging wrapping, there is a consequent simultaneous separation of the half-shells of edible material of the surprise container, and which also enables the consumer, after the removal of the wrapping, to have an immediate visual perception of the presence of the container.

A solution to this problem is described in EP 0 951 835 A and EP 1 018 302 A. In the packages described in these documents, the container is equipped with a rib against which the mouth edges of the edible half-shells bear; this rib therefore keeps the two edible half-shells separate and is visible from the outside after the removal of the wrapping foil. Thus the consumer has an immediate perception of the presence of a non-edible body placed between the edible half-shells.

The present invention provides a solution which improves the visibility of the container after the removal of the wrapper from the product.

Thus one object of the invention is a package for a food product and a method for its production, having the characteristics defined in the claims below, which form an integral part of the present description.

Further characteristics and advantages of the package proposed by the invention will be apparent from the following detailed description, which refers to the attached drawings, relating to the embodiment which is commonly used, but is not essential and does not limit the scope of the invention, in which two half-shells of edible material are of semi-ovoidal shape.

In the attached drawings,

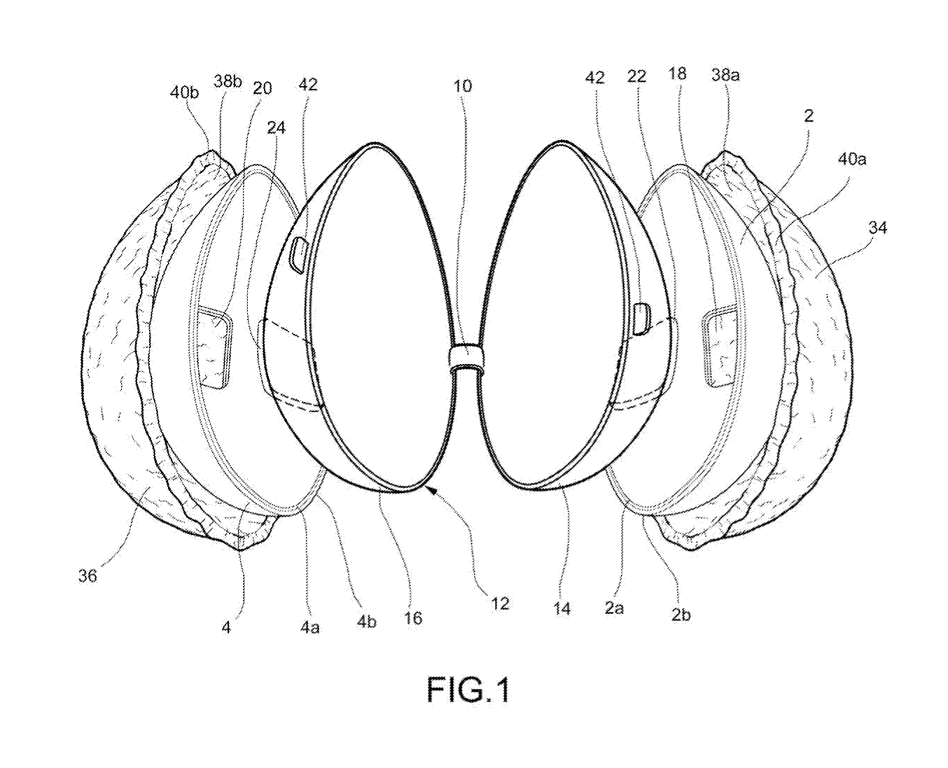

FIG. 1 is an exploded perspective view of an embodiment of the packaged product;

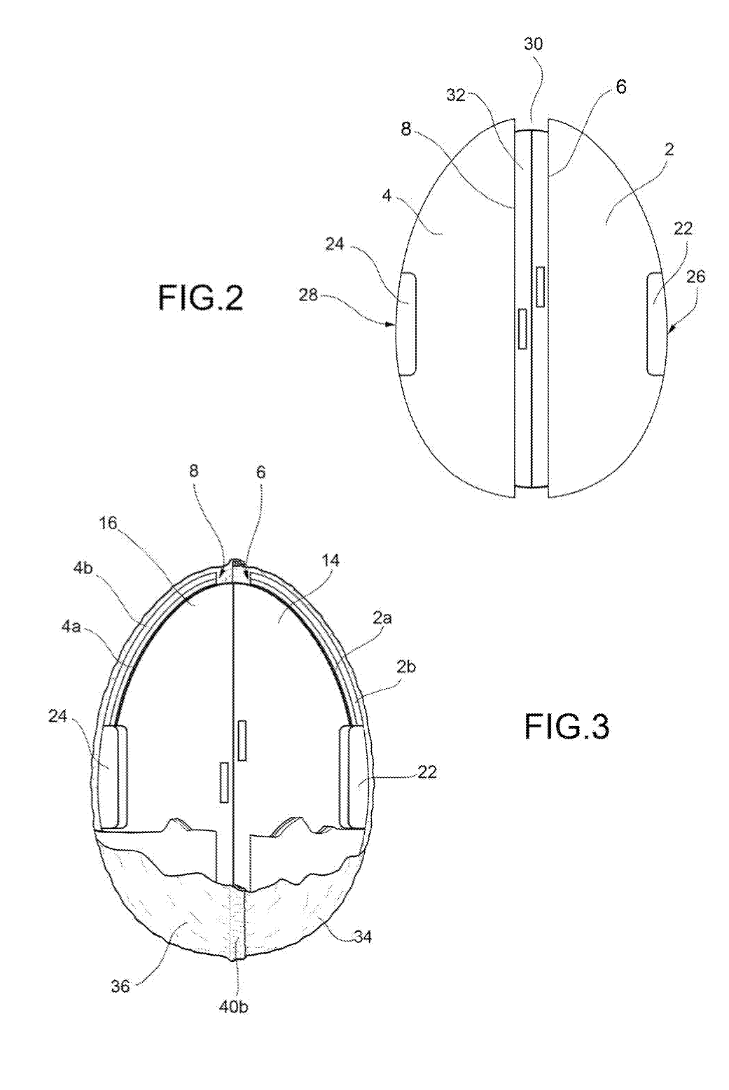

FIG. 2 is a front elevation of the product of FIG. 1, without the packaging wrapping,

FIG. 3 is a partially sectional view of the product of FIG. 1, with the corresponding packaging wrapping, and

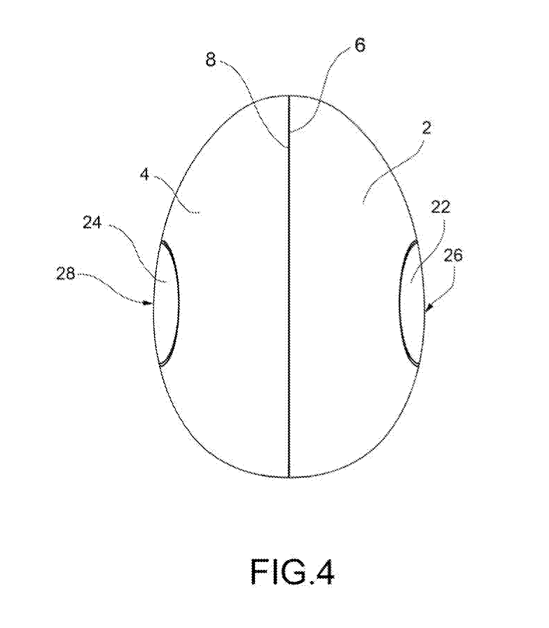

FIG. 4 is a front elevation of another embodiment, without a wrapping.

With reference to the drawings, the food product is formed by a first and a second half-shell 2 and 4 of semi-ovoidal shape. In all the illustrations, each half-shell is formed by two superimposed layers 2a, 2b and 4a, 4b, of white chocolate and milk chocolate or milk cream for example. The two half-shells 2 and 4 are placed with their respective annular mouth edges 6 and 8 in a mutually facing relationship, so as to define inside them a cavity in which is housed a container 12 of non-edible material, typically plastic material.

It is also to be understood that, although the annular mouth edges 6 and 8 have an ovoidal configuration in the illustrated configurations, the invention is also applicable to the case in which the edible part consists of two shells of which one forms the pointed end of the ovoidal body and the other forms the base part, and in which the mutually facing annular mouth edges therefore have a circular annular configuration.

The container 12 is typically made of plastic material suitable for contact with food, such as polypropylene or propylene-ethylene copolymer.

This container is, in turn, formed by two half-shells 14 and 16 that can be coupled mouth-to-mouth by simple contact or by engagement means for frontal joining so that, in the closed configuration of the container, the half-shells define within them a closed volume in which is housed a product or an accessory article forming the surprise.

Preferably, the two half-shells are connected to each other permanently by means of articulation 10, such as a film hinge or a snap hinge.

According to the invention, the wall of at least one of said first and second half-shell 2 and 4 of edible material, or preferably of both half-shells, has an opening 18, 20 with a closed contour (that is to say, a hole or perforation passing through the wall of the half-shell, the contour or perimeter of which is closed on to itself), which, in the absence of the outer packaging wrapping, defines a window which makes a portion of the wall of the container 12 visible from the outside; the contour of said window, which is square in the illustrated example, with rounded corners, may evidently have any configuration (for example, circular, elliptical or polygonal), provided that it can form a sufficiently large opening to allow the container to be viewed. Preferably, the aforesaid opening is positioned in the central base region of each half-shell 2 and 4 of edible material.

Half-shells of chocolate or similar thermoplastic mouldable edible material, the wall of which has an opening with a closed contour, can be made by conventional methods in use for forming half-shells with non-perforated walls (for example, by conventional methods of casting in a mould and turning over the mould), the opening being made afterwards by means of a punch; alternatively, it is to be understood that it is possible to use moulding methods that provide the half-shell with an opening as an end product, by using a suitable mould and counter-mould.

In the preferred embodiment, the wall of the container 12 in its region facing the aforesaid opening or openings has engagement means 22 and 24, shaped so as to engage the corresponding opening 18, 20, such that relative movement between the half-shell of edible material and the corresponding half-shell of the container is limited, or preferably prevented.

These engagement means 22, 20 may consist of an outwardly protruding formation made on the wall of the container, having a profile substantially complementary to, or homologous with, the closed contour of the respective opening; in the illustrated example, the engagement means 22 and 24 consist of a protruding portion of wall with a square or circular profile, which engages the contour of the respective opening and whose top surface 26, 28 is preferably flush with the surrounding outer surface of the wall of the respective edible half-shell 2 and 4 that surrounds said opening.

Although the solution in which the top surface of the engagement means is substantially flush with the outer surface of the wall of the shell of edible material is generally preferred, it will be readily appreciated that the aforesaid engagement means may have different configurations, for example an annular rib or ring with a profile complementary to the contour of the opening (not illustrated) or a plurality of elements protruding from the wall of the container and spaced apart from each other along a profile corresponding to the contour of the opening (not illustrated).

In general, when the aforesaid engagement means are present, the outer surface of each half-shell 14 and 16 forming the container, in its region surrounding the engagement means, is preferably complementary to the inner surface of the respective edible half-shell, so that the half-shells of the container also act as supporting elements for the respective edible half-shell.

A similar solution is used in the absence of the aforesaid engagement means.

In an embodiment (FIG. 2), the two half-shells 2 and 4 of edible material and the container are shaped and dimensioned relative to each other in such a way that the facing edges 6 and 8 of the two half-shells 2 and 4 are kept spaced apart so as to form a void gap 30 which, in the absence of the outer packaging wrapping, makes at least an annular portion of the wall of the container, indicated by 32 in FIG. 2, immediately visible from the outside.

In another embodiment (FIG. 4), the two half-shells 2, 4 of edible material are shaped so that their facing mouth edges 6 and 8 are in contact with each other.

One or both of the half-shells 14 and/or 16 may have one or more protruding tabs 42 placed below the mouth contour, which facilitate opening and may also act as a stop element for the respective half-shell of edible material.

The two half-shells of edible material 2 and 4 are housed in a respective shaped wrapping of foil material 34 and 36 which may be made by using a foil or film of metal, particularly aluminium, or may be formed by joining a metal film to a polymer film, or by using a metal foil or film coated with a heat-sealable lacquer.

Typically, the foils or films used have a thickness of 6 μm to 40 μm, or preferably 8 μm to 20 μm, for example 12 μm.

Each wrapping 34 and 36 has a hollow receiving portion 38a, 38b shaped in a substantially complementary manner to the outer surface of the respective edible half-shell 2 and 4, so as to adhere to this surface, and a peripheral portion 40a and 40b in the form of a flange.

The wrappings 34 and 36 are initially associated with the respective edible half-shell 2 and 4 with the flange portions 40a , 40b in a superimposed relationship; these portions are then coupled to one another by bending and/or crimping, thereby forming a disengageable connection between the two wrappings.

Alternatively, the peripheral flange-shaped portions may be interconnected by gluing or welding, which may be performed by providing a heat-sealable lacquer on the facing peripheral surfaces.

After welding, these peripheral portions welded together can be bent back on to themselves and, if necessary, crimped against the outer wall of one of the two wrappings.

In this embodiment, it is preferable for the welding area for providing a hermetic closure of the package to be provided in a terminal region of the superimposed flange-shaped peripheral portions 40a and 40b, or at least in a region spaced apart from the receiving portion, and for the bending of the flange, in an orthogonal or inclined direction relative to the plane of the superimposed flanges, to be performed along a bending line which does not pass through the welding area, so that this welding area is present in a distal region of the two bent flanges, to avoid damage to the chocolate by the heat emitted from the welding tool.

According to the invention, the two wrappings of foil material, interconnected along their flange edges by gluing, welding or bending/crimping or by a combination of these methods, have an important function of retaining the edible half-shells in the assembled configuration of the package.

Although the use of these packaging wrappings is known, for example, from EP 2 252 528 B1, this use has hitherto mostly been confined to the packaging of a hollow body formed by two interconnected edible half-shells; in this case, these wrappings have the conventional aesthetic and protective function.

According to the invention, the two wrappings described above not only provide the aforesaid conventional aesthetic and protective functions, but can also provide a retaining function, when the two edible half-shells, which are separate from each other, are kept in contact with the non-edible container, with the facing annular edges in a substantially equidistant relationship.

In order to provide the aforesaid retaining function, it is also possible to use two wrappings of foil material, identical to each other as previously illustrated, or not identical to each other, that is to say a first wrapping which is larger than the other, so that the plane in which the flange-shaped peripheral portions 40a and 40b lie does not coincide with a plane of symmetry of the package, and therefore is not equidistant from the separate mouth planes of the two half-shells of edible material.

For the use of this variant, the two wrappings of foil material may be shaped as described in EP 1110863 A. However, the invention is also applicable to identical wrapping half-shells.

The method for producing the package may be executed by means of the following operations:

forming a first wrapping 34 of foil material shaped with a receiving portion 38a and a flange-shaped peripheral portion 40a;

inserting into the first wrapping shaped in this way a first half-shell of edible material 2 provided with an opening 18, the outer surface of which is shaped in a form substantially complementary to the receiving portion of said first wrapping foil (so that said outer surface can contact the surface of the aforesaid receiving portion) and has a depth (in the sense of the distance between the mouth plane of said edible half-shell and the base of the half-shell) such that, when the half-shell is inserted into the respective wrapping, its mouth plane is lowered (that is to say, spaced apart towards the inside) relative to the plane of said peripheral portion of the wrapping;

inserting a container 12 of non-edible material into said edible half-shell, and, if said container is provided with engagement means 22, positioning said engagement means inside the respective opening 18;

positioning in contact with the outer surface of the container 12 a second half-shell of edible material 4 (optionally provided with a respective opening 20) with its mouth edges facing the mouth edges of the first half-shell of edible material; if the container 12 is provided with engagement means 24, positioning said engagement means inside the opening 20 on both the half-shells forming the container; the dimensions and shape of the container and said half-shells of edible material preferably being such that, when the second half-shell of edible material is positioned so as to bear on the outer wall of the container, the annular mouth edges of the first and second half-shell of edible material are separated from one another, forming a void gap 30 between them;

positioning on the outer surface of the second half-shell of edible material a second wrapping of foil material 36, having a receiving portion 38b shaped in a substantially complementary manner to the outer surface of the edible half-shell 4 and a flange-shaped peripheral portion 40b, said second wrapping of foil material 36 being dimensioned in such a way that, when positioned in contact with the edible half-shell 2, its flange-shaped peripheral portion 38b is in contact with the flange-shaped peripheral portion 38a of the first wrapping foil; and

connecting said peripheral portions into a coupled configuration by the aforementioned methods, comprising gluing, welding or bending of the flange edges and crimping if necessary (known as “edge forming” in the technical jargon), or a combination of these methods.

As mentioned above, the connection of the peripheral portions enables the integrity of the package to be maintained; after the removal of the wrapping, the two edible half-shells are separated, and the presence of the container of non-edible material is immediately perceptible through the opening or openings 18 and/or 20.

Clearly, provided that the principle of the invention is retained, the forms of application and the details of implementation can be varied from what has been described by way of example, without departure from the scope of the following claims.

1. Food product package, comprising a first (2) and a second (4) half-shell of edible material, each having a respective annular edge (6, 8), said first and second half-shell of edible material being arranged with their respective annular edges in a mutually facing relationship, an openable container (12) of non-edible material interposed between said half-shells, having a wall that defines an internal volume for housing a product, article or accessory, wherein said first and second half-shell of edible material (2, 4) are accommodated in a respective wrapping (34, 36) of sheet material defining a cavity substantially complementary to the outer surface of the respective half-shell of edible material, said wrappings (34, 36) being connected to each other along their respective edges (40a, 40b) so as to maintain the half-shells of edible material (2, 4) in contact with the container wall, characterized in that the wall of at least one of said first and second half-shell of edible material (2, 4) has an opening with a closed contour (18, 20) defining a window that makes a portion of the container wall visible from the outside.

2. Package according to claim 1, characterized in that the wall of said container (12) has in its region facing said opening(s) engagement means (22, 24) shaped so as to be insertable into the respective opening (18, 20) for limiting the relative movement between the container and the edible half-shell.

3. Package according to claim 1, characterized in that said engagement means (22, 24) comprise a formation protruding towards the outside of the container wall having a profile complementary to the contour of said opening (18, 20).

4. Package according to claim 2, characterized in that, in the assembled configuration of the packaging, the top surface of said engagement means (22, 24) is substantially flush with the outer surface of the respective half-shell of edible material (2, 4) surrounding said engagement means.

5. Package according to claim 2, characterized in that said container (12) comprises a pair of half-shells (14, 16) of plastic material, wherein each half-shell of plastic material has respective engagement means (22, 24) adapted to engage the corresponding opening (18, 20) formed in the half-shell of edible material (2, 4) coupled to it.

6. Package according to claim 1, characterized in that said first and second half-shell of edible material (2, 4) and said container (12) are dimensioned and shaped in such a way that the container (12) keeps the facing edges (6, 8) of said half-shells of edible material (2, 4) spaced apart, so that there is defined between said edges (6, 8) a void gap (30) that makes at least one annular portion (32) of the container wall (12) visible from the outside.

7. Package according to claim 1, characterized in that said first and second half-shells of edible material are dimensioned and shaped in such a way that the facing edges (6, 8) of said half-shells are in contact with each other.

8. Package according to claim 1, characterized in that said wrappings (34, 36) of foil material comprise a receiving portion (38a, 38b) and a peripheral portion (40a, 40b) in the form of a flange, and in which said peripheral portions are interconnected by gluing, welding, bending and/or crimping, or by a combination of gluing or welding with bending and/or crimping.

9. Package according to claim 1, characterized in that said container (12) comprises two half-shells of plastic material (14, 16) whose outer surface is substantially complementary to the inner surface of said half-shells (2, 4) of edible material, excluding the wall region facing said opening(s) (18, 20).
